(19) United States
(12) Patent Application Publication
(10) Pub. No.: US 2016/0311365 A1
(43) Pub. Date: Oct. 27, 2016

(54) Device and Method for Validating License Plate Tags, a/k/a PROOF

(71) Applicant: Rachel LaNora Hankerson, St. Louis, MO (US)

(72) Inventor: Rachel LaNora Hankerson, St. Louis, MO (US)

(21) Appl. No.: 15/003,240

(22) PCT Filed: Aug. 20, 2014
(86) PCT No.: PCT/US14/51924

§ 371 Date: Jan. 21, 2016

Related U.S. Application Data
(60) Provisional application No. 61/868,051, filed on Aug. 20, 2013.

(51) Int. Cl. B60Q 1/56; G06Q 40/08; B60R 13/10

(52) U.S. Cl. CPC B60Q 1/56; B60R 13/10; G06Q 40/08; B60Q 2900/30

(57) ABSTRACT

A device and method for validating license plates has a central server in communication with third party databases, external communication means, a fleet of indicators upon license plates of vehicles, and the indicators communicating to the central server. The central server receives input from insurance company, vehicle registration, law enforcement, and subscriber databases. The central server compares a license plate or other data to criteria. Upon meeting one criterion, the central server sends a signal through the communication means to an indicator upon a subscriber's license plate for illumination. Upon failing another criterion, the central server communicates a different signal to an indicator for intermittent illumination. The central server also has an emergency function that a subscriber may activate which illuminates the indicator. The indicator unit has an antenna, a battery, a connection to a vehicle's electrical system, a microprocessor, and a light emitting diode.

### CROSS-REFERENCE TO RELATED APPLICATION

This non-provisional application under the Patent Cooperation Treaty (PCT) claims priority to the pending provisional application 61/868,051 filed on Aug. 20, 2013 and all of which are owned by the same inventor.

### BACKGROUND OF THE INVENTION

The device and method for validating license plates generally relates to wirelessly activated signals and more specifically to a database that activates a light upon a license plate. The light activates for a lapse of vehicle insurance coverage, lapse of registration of the vehicle, or both.

For millennia, people have sought to move and move faster each year from place to place on land. People started movement on foot then impressed various animals into service as transport. For at least the last three thousand years, people in a hurry have rode horses or used horse drawn livery. Horses served well for speedy travels until the middle of the 1800s when railroads formed. Trains upon rails achieved faster speeds than horses and hauled more tonnage of cargo. The railroads though extended from point to point in a fixed network while horses could travel to most towns, even those beyond railroads.

Then industrialist Henry Ford developed and mass produced an automobile. The initial automobile, the Model T, had phenomenal sales and soon automobiles, or cars, proliferated both domestically and abroad. Production of cars spurred further construction of roads between most towns and to nearly every doorstep in the country. Following World War II, Congress authorized construction of the interstate highway system with the first miles of interstate built in Missouri. The interstate system then established a network of limited access and high speed highways between major cities. People presently travel from place to place at speeds that make visiting other cities in the same day possible.

With the proliferation of cars and roads, from time to time, cars have collisions, or accidents. The collisions range from bumper taps, fender benders, one car accidents, on up to multi vehicle accidents. Minor collisions damage vehicles and nearby property, other accidents lead to fatalities. Presently, nearly 36,000 fatalities occur on the roads annually. In the earlier years of automobiles, collisions caused the parties involved to litigate a resolution to the damage. Motorists who carried insurance avoided the hassles of litigation. Motorists without insurance remained in litigation and then faced collection of judgments. Some motorists though have judgment proof status where they lacked any assets to satisfy a judgment.

With insurance available, various states have imposed an obligation upon motorists to purchase and to carry automobile insurance, usually in a minimum amount. The automobile insurance provides liability coverage at a minimum and may also include various property coverages upon election by the insured, a motorist. Insurance companies have established sufficiently large pools of insured to pay premiums and thus defray the costs of covered claims. From time to time, states adjust their mandatory minimum coverage and motorists adjust their lines of insurance and coverage.

### DESCRIPTION OF THE PRIOR ART

The heart of an auto insurance arrangement is the policy itself. The policy spells out the coverage, exclusions from coverage, the premium, the duration, and the like regarding the insured and the insurer. The policy has written form to comply with the statute of frauds adopted in most states. The policy may have a length growing to the tens or hundreds of pages from time to time. For an insured to carry such a document in her vehicle, for a registration clerk to review the same document in a busy office, and for a police officer to inspect the same document puts a burden on the likely parties to check that an insured has a policy.

Insurance companies in coordination with the various state insurance regulating offices have developed a proof of insurance much easier to handle for insureds, registration clerks, police officers and the like. The present proof of insurance is generally a paper document slightly larger than a three inch by five inch card. Previous generations of proof of insurance included card stock paper. The paper proof of insurance allows motorists to readily store the paper proof in their vehicle and to produce it upon demand for a police officer or to present it to a registration clerk. The paper proof of insurance typically lists the insurance company, the insured vehicle, the insured's name, and related information.

Being paper, the current proof of insurance remains subject to the weaknesses of paper. Paper proof can be lost, misplaced, made illegible by water, sunlight, beverages, and the like, burned, and to some extend counterfeited.

Insurance companies have a partial response to the weaknesses of paper proof of insurance with their proprietary databases. The insurance companies know their insureds, the status of the insured's policies, and the status of the insured's premiums. However, such databases remain business records of the insurance companies. Insurance companies resist sharing portions of their databases, let alone the entire databases with regulating state insurance offices and law enforcement.

Because of the paper proof of insurance documents and guarded insurance company databases, verifying proof of insurance occurs at the regular interval of vehicle registration and the irregular interval of an auto accident. In between the regular and irregular opportunities to verify proof of insurance, insureds and their vehicles fail to regular display proof of insurance. The proof of insurance remains in the glove compartment, rarely to be seen.

Beyond paper proof of insurance, various communication systems show the status of mobile units separated from a base. U.S. Pat. No. 5,289,163 to Perez et al. discloses a child position monitoring and locating device that emits a continuous signal from a transmitter carried by a child to a receiver held by a parent. However, the Perez patent does not accept identifying information about children, and has further drawbacks of no keyboard and no signal transmission to a satellite.

U.S. Pat. No. 4,785,291 to Hawthorne discloses a distance monitor especially for child surveillance that monitors a child at a predetermined range and notifies a parent by sight and sound of the distance to a wandering child. However, the Hawthorne patent does not have a text or graphic display, and additionally does not attach a transmitter to the skin of a child and has no signal transmission to a satellite.

U.S. Pat. No. 5,748,087 to Ingargiola et al. discloses a remote personal security device that monitors children at adjustable ranges and notifies a parent by sight and sound of the distance to a wandering child. In one application, the Ingargiola patent has a transmitter located within the soles of a child's shoes. This application may face heightened scrutiny during airport screening. However, the Ingargiola patent does not have a keyboard for entering information, and additionally does not emit signals to satellites.

Similarly, U.S. Pat. No. 5,650,770 to Schlager et al. discloses a self locating remote monitoring device that conserves transmitter power by using a polling signal to summon the transmitter's location when the transmitter exceeds a predetermined distance or encounters a hazard. However, the

Schlager patent does not have a keyboard in the base station to enter identifying information for the wearer of the transmitter, and cannot monitor multiple remote units.

Similarly, U.S. Pat. No. 5,771,002 to Creek et al. discloses a tracking system using radio frequency signals that identifies the unique codes of multiple transmitters and reradiates signals to ascertain the distance to a transmitter. However, the Creek patent does not accept text and numeric information into the receiver from a parent, and cannot transmit a signal to an orbiting satellite.

Lastly, U.S. Pat. No. 6,363,324 to Hildebrant discloses a vehicle locating system that provides a vehicle location via the GPS satellite system. However, the Hildebrant patent does not accept identifying information about children, and has further drawbacks of no keyboard and no internal power source for the locator unit.

The present invention overcomes the disadvantages of the prior art and provides a device and method for validating license plates for real time display of insurance status of a vehicle. The device utilizes a lighting source powered from a vehicle's electrical system and the method regulates the lighting source based upon information from insurance company, vehicle registry, and other databases.

### SUMMARY OF THE INVENTION

Generally, the device and method for validating license plates has a central server in communication with third party databases, external communication means from the central server, a fleet of indicators deployed upon license plates of vehicles, and the indicators communicating to the central server. The central server receives input from insurance company databases, governmental vehicle registration databases, law enforcement databases, a database of subscribers, and the like. Each subscriber identifies a license plate or other date suitable for verifying insurance status and registration status. The central server accepts that input and compares it to criteria. Upon meeting one criterion, generally positive, the central server sends a signal through the communication means to an indicator upon a subscriber's license plate for illumination. Upon failing another criterion, generally a negative event, the central server communicates a different signal to an indicator on the subscriber's license plate for different illumination. The central server also has an emergency function that a subscriber may activate which illuminates the indicator without the central server making a comparison against a third party database. The invention also includes an indicator unit installed upon a license plate. The indicator unit has an antenna, a battery, a connection to a vehicle's electrical system, a microprocessor, and a light emitting diode assembly. There has thus been outlined, rather broadly, the more important features of the invention in order that the detailed description thereof that follows may be better understood and that the present contribution to the art may be better appreciated. The present invention also includes interfaces of the central server to the various third party databases, cyber security measures upon the central server, external communication through cellular telephone and short message system, and various colors for the LED assembly. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways, such as on any form of transportation, not limited to bicycles and wheel chairs as to alert these entities of surrounding traffic as it communicates with the license plate to illuminate specified colors. Also, the phraseology and terminology employed herein are for the purpose of description and should not be regarded as limiting.

One object of the present invention is to provide a device and method for validating license plates that identifies a vehicle having insurance coverage and paid taxes, a vehicle lacking insurance coverage, a vehicle not having paid taxes, and a vehicle without insurance and unpaid taxes.

Another object is to provide such a device and method for validating license plates that operates upon the electrical supply of a vehicle. Another object is to provide such a device and method for validating license plates that wirelessly signals the device to illuminate.

Another object is to provide such a device and method for validating license plates that interfaces a database of vehicles with insurance company databases and vehicle taxing authority databases to identify vehicles with insurance, without insurance, having paid vehicle taxes, and having unpaid vehicle taxes.

Another object Is to provide such a device and method for validating license plates that installs upon a vehicle with semiskilled or unskilled labor.

Another object is to provide such a device and method for validating license plates that resists tampering by vehicle owners and operators.

Another object is to provide such a device and method for validating license plates that reduces time expended in locating a vehicle during an emergency.

Another object is to provide such a device and method for validating license plates that identifies undocumented immigrants.

Another object is to provide such a device and method for validating license plates that assists in tracking persons and vehicles under investigation for civil or criminal charges.

Another object is to provide such a device and method for validating license plates that assists in tracking persons restricted in their movements by court order.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 is a flow chart of the method of the invention;

FIG. 2a is a flow chart of a component of the method;

FIG. 2b is a flow chart of another component of the method;

FIG. 3 is a front view of an indicator device installed upon a license plate;

FIG. 4 is a front view of the indicator with its cover removed;

FIG. 5 is an exploded view of an installation of the indicator device; and,

FIG. 6 is a back view of an auto with the indicator device installed.

The same reference numerals refer to the same parts throughout the various figures.

### DESCRIPTION OF THE PREFERRED EMBODIMENT

The present invention overcomes the prior art limitations by providing a device and method for validating license plates. The present invention is a computerized license plate and related software with the design of a universal improved means of validating auto insurance, vehicle registration, and response time when locating a vehicle during the instance of an emergency. The present invention will display a solid color light when insured and a secondary color light when not insured. The present invention will also display a solid color light when registered and a secondary color light when not registered. The present invention will also display a flashing, or intermittent, color light during an emergency to improve law enforcement/department of homeland security response time to an accident, crime, kidnap, and the like.

Each public and private auto insurance company will have a line of communication with the present invention, typically into the central server as later described. Once a motorist pays an auto insurance premium, a specified insurance company will automate a unique identifier and transmit/send a signal to the license plate, by way of Department of Motor Vehicle (DMV) System, to validate that the vehicle's owner has accurate, current, and secured proof of auto insurance. The central server, as later described, has an automated calendar for the policy expiration date, from which the motorist would receive reminders as to when the expiration date approaches. A motorist also has the name of subscriber in this description. Once the insurance for the vehicle lapses, then the light, or indicator, changes to another color that reflects an uninsured status.

The Department of Motor Vehicles (DMV) or other vehicle registry agency will have a line of communication with the present invention, particularly its central server. Once a motorist properly registers a vehicle, the DMV will automate a unique identifier and transmit/send a signal an indicator upon the license plate to validate that the specified vehicle has proper registration with that particular state's DMV or equivalent. The invention also includes a calendar with an automated time set for expiration of the registration and from which the motorist will receive reminders as to an approaching expiration date. Once the vehicle's registration lapses, the indicator or light changes to another color to reflect not registered.

Law enforcement also has a line of communication with present invention through the central server. During the instance of an emergency, an inquiring person, business entity, or other government agency may provide to law enforcement the vehicle identification number or VIN/License Plate Number of a vehicle equipped with an indicator upon a license plate. The law enforcement would then direct the central server to send a panic signal to the indicator vehicle which identifies the vehicle by an intermittent light. That light would then guide law enforcement or other responding agency to the vehicle for an improved response time. After conclusion of the situation, law enforcement will direct the central server to disable the panic signal.

The present invention will bridge the infrastructure between the auto insurance industry, department of motor vehicles, and law enforcement. Currently the auto insurance industry, department of motor vehicles, and law enforcement serve as separate entities, but have overlapping operations. For example, when a motorist is pulled over by law enforcement for speeding, the officer would ask for a driver's license and proof of auto insurance, at the time of the stop, the officer would also verify the registration of the vehicle with the state department of motor vehicles. In this scenario, the auto insurance industry, department of motor vehicles, and law enforcement serve as separate entities, while having over lapping operations.

This current process does not initiate accountability through validation because the officer cannot check for an actual, current, and secured policy of auto insurance with the card presented by the motorist. The card may reflect all of the correct information, but does not validate its accuracy or currency. The vehicle may have a registration tag associated with it, but does not validate that the vehicle has proper registered currently in force.

A great possibility remains that the registration tag may apply to another vehicle. The present invention eliminates the probability of these errors. The present invention has improved the process of validation with reference to auto insurance, vehicle registration and law enforcement. The computerized license plate would be declared as one manufactured unit. The present invention will follow a universal structure of the aluminum license plate, with an embedded monitoring system. The design and sizing of the computerized license plate, of this invention, meets the legal standards and requirements of each country and state within a country.

The present invention will also use satellite/GPS communications; cell tower network; and solar power with backup battery capabilities as later described. The present invention will also utilize the latest communications network as they improve over time.

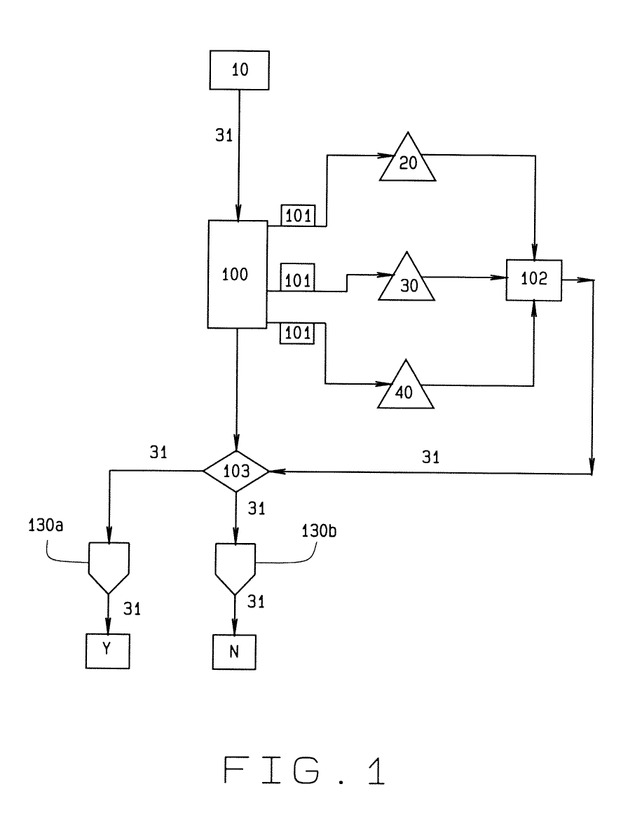

As described above, many motorists operate many vehicles across the country on trails, roads, highways, bridges, and interstates. The motorists remain subject to state mandated insurance and vehicle registration. Motorists also expect prompt response in the event their vehicle becomes stolen. FIG. 1 provides a flow diagram of the present invention's method 1. The invention begins with assembling a pool of subscribers, as at 10. The subscribers can be motorists, vehicle owners, the operators of vehicle fleets, and the like. The subscribers may volunteer to utilize the invention, pay to use the invention, or be compelled by statute to utilize the invention.

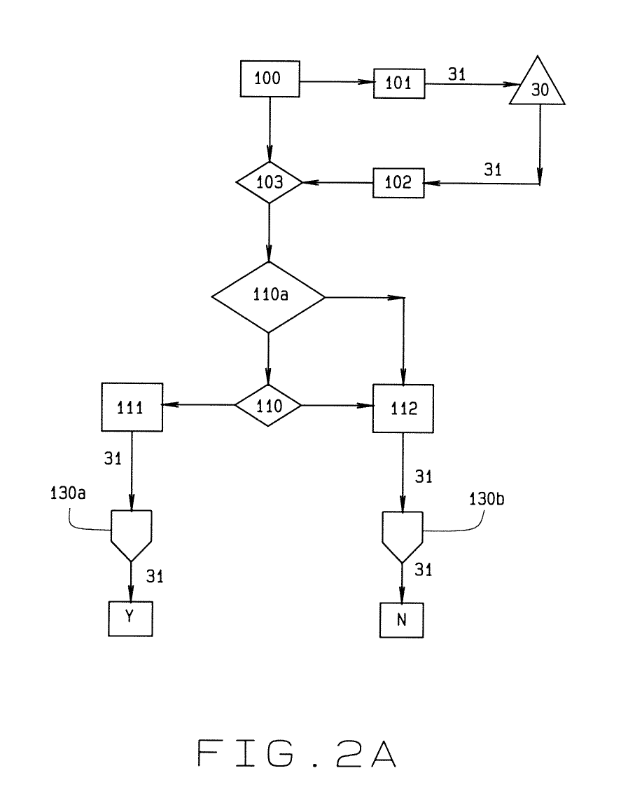

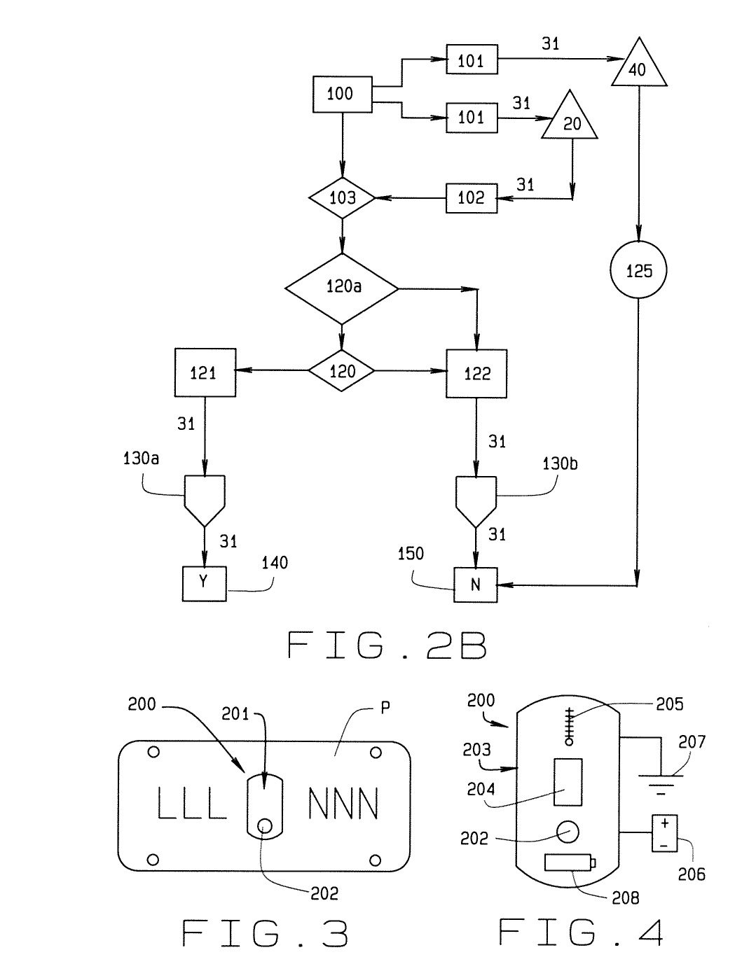

The subscribers then enter information about themselves and their vehicles into a central server as at 100. The central server receives data from subscribers, queries third party databases, verifies subscriber data, automatically creates a unique identifier, and then issues an appropriate signal to a plurality of indicators deployed upon vehicles. The subscribers begin with entering the pertinent information, vehicle identification number, or VIN, the owner name, insurance policy carrier, and insurance policy expiration date into the central server. The central server places that information into a subscriber file as at 101, which reflects the automated generated unique identifier. The central server also includes real time telecommunications links, as at 31, into third party databases within the United States. The third party databases include insurance company databases as at 30, governmental vehicle registry databases as at 20, and law enforcement databases as at 40. In an alternate embodiment, third party databases include the insurance, vehicle registry, and law enforcement databases of foreign nations. The central server submits the VIN, owner name, and automated unique identifier of a subscriber to the insurance company databases 30 and those databases' returns the unique identifier which is comprised of portions of the of the owner name being insured or not and the VIN as being insured or not as later shown in FIG. 2a. The central server adds the insurance company databases returns to the query result file as at 102. The central server submits the unique identifier, which is comprised of the VIN and owner name of a subscriber to the government vehicle registry databases as at 20 and those databases returns of the VIN being registered or not as later shown in FIG. 2b. The central server adds the government vehicle registry databases returns to the query result file as at 102. And, the central server submits the unique identifier, VIN of a subscriber to the law enforcement databases, including the National Insurance Crime Bureau as at 40 and those databases return whether the unique identifier, VIN has been reported as stolen or not. In the event of a reported stolen VIN, the central server bypasses the query result file as at 102 and sends a signal immediately to an indicator as later shown in FIG. 2b.

After filling the query result file 102, the central server completes a comparison, as at 103, of the query result file against criteria. Those criteria include whether the subscriber's name is an insured, whether the VIN is an insurance covered vehicle, whether the VIN is registered with a governmental registry, and whether the VIN is not on a law enforcement database, identified through a unique identifier. If any of those criteria result in a negative answer, the central server then sends a signal through telecommunications links as at 130b to an indicator which illuminates an intermittent light as at 150 upon a vehicle mounted indicator to get attention, called the No Proof scenario. If all of those criteria result in a positive answer, the central server then sends a signal through telecommunications links as at 130a to an indicator which illuminates a constant light as at 140 upon a vehicle mounted indicator, called the Proof scenario. In an alternate embodiment, if all of those criteria result in a positive answer, the central server sends no signal to a vehicle mounted indicator and a light thereon remains darkened.

FIG. 2a shows a component of the invention. The central server 100 has its subscriber file 101 as described above and its link to the insurance company databases as at 20. The central server also has the query result file as at 102. The query result file has the returns from the insurance company databases 20. The returns include whether or not the owner name appears as being insured shown in the database 20 and whether or not the VIN appears on a list as being insured. The central server then runs the query result file 102 through the comparison 103. Initially, the comparison checks if the unique identifier, which reflects the owner name and the VIN are listed as being insured as at 110a. If the owner name and the VIN do not appear in any insurance company database, the comparison yields a negative signal as at 112. The central server then sends a signal to the indicator as at 130b to intermittently illuminate. If the owner name but not VIN appears in any insurance company database, the comparison yields a negative signal as at 112 and the central server signals the indicator as at 130b to illuminate intermittently. If the VIN but not the owner name appears in any insurance company database, the comparison yields a negative signal as at 112. The central server signals the indicator as at 130b to illuminate intermittently, and in an alternate embodiment triggers a check through law enforcement databases. The comparison 103 then determines the expiration date of an insurance policy upon the VIN in the owner's name and compares that expiration date to the present date as at 110. If the present date is before the expiration date, the central server yields a positive signal as at 111. The central server then signals the indicator to illuminate steadily as at 130a.

FIG. 2b shows another component of the invention which may run in parallel with the component shown in FIG. 2a. The central server 100 has its subscriber file 101 and query result file as at 102 as described above and its links to the governmental vehicle registry databases as at 20 and law enforcement databases as at 40. The query result file has the returns from the governmental vehicle registry databases as at 20 and law enforcement databases as at 40. The returns include whether or not the VIN appears as being registered shown in the database 20 and whether or 5. not the VIN appears on the law enforcement databases. In the event of a reported stolen VIN from the law enforcement databases, the central server bypasses the query result file as at 102 and sends a signal immediately, as at 125, to an indicator as at 130b to illuminate intermittently. Along with stolen vehicles, the query result file 102 may yield additional information from law enforcement. In the event of a single vehicle emergency, such as a motor vehicle accident, the query result file indicates the vehicle with the invention on board has ceased movement and an accelerometer on the vehicle has detected a collision. The central server then sends a signal immediately, as at 125, to an indicator as at 130b to illuminate intermittently and notifies law enforcement near the vehicle of the accident. This prompt notification of law enforcement reduces the time spent locating a vehicle during an emergency. In the event of the invention identifying a vehicle as without insurance and alternatively without registration and illumination of the indicator as at 130b by the central server, the invention may draw the attention of passing law enforcement to the vehicle. Vehicles without insurance and without registration often carry or transport persons often called undocumented immigrants. Law enforcement upon finding such persons then takes appropriate action.

In coordination with the stolen vehicle notification as at 125 of the invention, the invention also assists in tracking persons and vehicles under investigation for civil or criminal charges. The invention by its communication to law enforcement and insurance databases can provide a location of a vehicle and by inference the persons inside of it. That location information may have use to law enforcement and other investigators pursuing charges against a person in a vehicle equipped with the invention. Following an investigation and court proceeding, persons often have restrictions imposed upon their movements. Those restrictions include time of day, distance, radius of travel, and enforcement of state boundaries. The present invention with its signaling to law enforcement databases of a vehicle's position, and the inferred position of persons inside the vehicle, provides useful information to track a person against movement restrictions. Upon a breach of such a restriction, the invention can send a signal similar to that of the stolen car signal 125 and triggering the indicator to illuminate as at 130b.

For other vehicles in normal ownership, the central server then runs the query result file 102 through the comparison 103. Initially, the comparison checks if the VIN is listed as being registered as at 120a. If the VIN/unique identifier does not appear on any governmental vehicle registry database, the comparison yields a negative signal as at 122. The central server then sends a signal to the indicator as at 130b to illuminate intermittently. The comparison 103 then determines the expiration date of a registration upon the VIN/unique identifier and compares that expiration date to the present date as at 120. If the present date is before the expiration date, the central server yields a positive signal as at 121. The central server then signals the indicator to illuminate steadily as at 130a.

The invention has its central server 100 at a central location such as an office or possibly in a secure portion of the computing cloud. Upon completing the various comparisons 103 described above, the central server sends a signal through a telecommunications system as at 130a or 130b, to an indicator 200 shown mounted upon a license plate P in FIG. 3. The license plate is generally metal, preferably aluminum, and have various combinations of letters, numerals, and select characters, or license plate number, as permitted by state or federal law. The various governmental vehicle registry databases, 20, keep track of the various combinations of letters, numerals, and characters upon the fleet of license plates in their jurisdictions. The present invention includes its indicator 200 generally mounted upon the center of a license plate as shown in FIG. 3. This location of the indicator allows for display of the license plate number for use by law enforcement officers and the public. The indicator has a permanent mounting to the plate via adhesive, rivet or other mechanical means, or welding. The mounting may be performed by the subscriber or alternatively, by the supplier of the plates to the government vehicle registry. In the event a person seeks to detach the indicator from the license plate, the plate deforms or the indicator tears the plate so that law enforcement can identify a tampered indicator and plate.

The government vehicle registry agencies typically require a license plate upon the rear of a vehicle and some agencies also required plates upon the front of the vehicle. The present invention applies its indicator to the license plates on the front and the rear of the vehicle with a minimum of the rear of the vehicle. Federal and state transportation regulations also require lighted illumination of the rear license plate upon engaging the ignition or the park lights of a passenger vehicle. Most passenger vehicles have a small white light aimed upon the rear license plate to meet the regulation. The present invention utilizes power through the circuit of the rear license plate light for its indicator. The indicator 200 has a cover 201 visible outwardly from the license plate P. The cover allows for illumination of a light 202 but otherwise conceals the remainder of the indicator tightly upon the plate P. Prior to installation of the cover 201, the invention's indicator 200 shows its internal components as at FIG. 4. The indicator has a case 203, here shown as an elongated prismatic rectangle, proportional to the license plate numbers and oriented parallel to the long axis of the license plate numbers, that is, parallel to the short side of a license plate. In an alternate embodiment, the case includes a metal flange outwardly so that the flange may be welded to a license plate. Alternatively, the flange is joined to the license plate with an adhesive suitable for exposure to water and a rough environment. Within the case, the indicator has a processor 204 in communication with an antenna 205. The antenna has a configuration to receive the various signals from the central server 100 sent over various telecommunications networks 130, such as cellular telephone, text or SMS message, microwave, radio, infrared laser, satellite GPS 2F6, and the like. The processor also has electrical communication to the vehicle electrical system as at 206 and a ground if needed as at 207. The case also includes a battery 208 as a reserve power supply to the processor and light 202. The battery supplies similar current at a similar voltage to the vehicle electrical system. The battery has a design life of two and one half years, including the renewal cycle of a government vehicle registry and shelf time prior to issuance. In an alternate embodiment, the case has at least one solar cell that operates the processor and antenna and further alternatively recharges the battery.

During use, the antenna 205 receives a signal and relays that signal to the processor 204. The processor has its electrical power from the vehicle electrical system or alternatively from the battery as when the key is removed from the ignition and no park lights are present. The processor then determines what type of signal has arrived. The processor then releases constant power to the light 202 for a steady indication visible to the public and law enforcement upon a positive signal from the central server, the PROOF scenario. But, the processor releases intermittent power to the light 202 for an intermittent indication visible to the public and law enforcement upon a negative signal from the central server, the NO PROOF scenario. Upon viewing an intermittent light 202 upon an indicator, law enforcement can investigate the vehicle further. Preferably, the indicator remains illuminated but for a negative signal. Alternatively, the indicator has its light 202 generally off unless a negative signal is present. The light 202 may take many forms from an automotive incandescent bulb to a light emitting diode.

Also, upon a subscriber rectifying her insurance coverage or vehicle registration, the central server verifies this with the appropriate databases. The central server then sends a positive signal to reset the light 202 to the PROOF scenario.

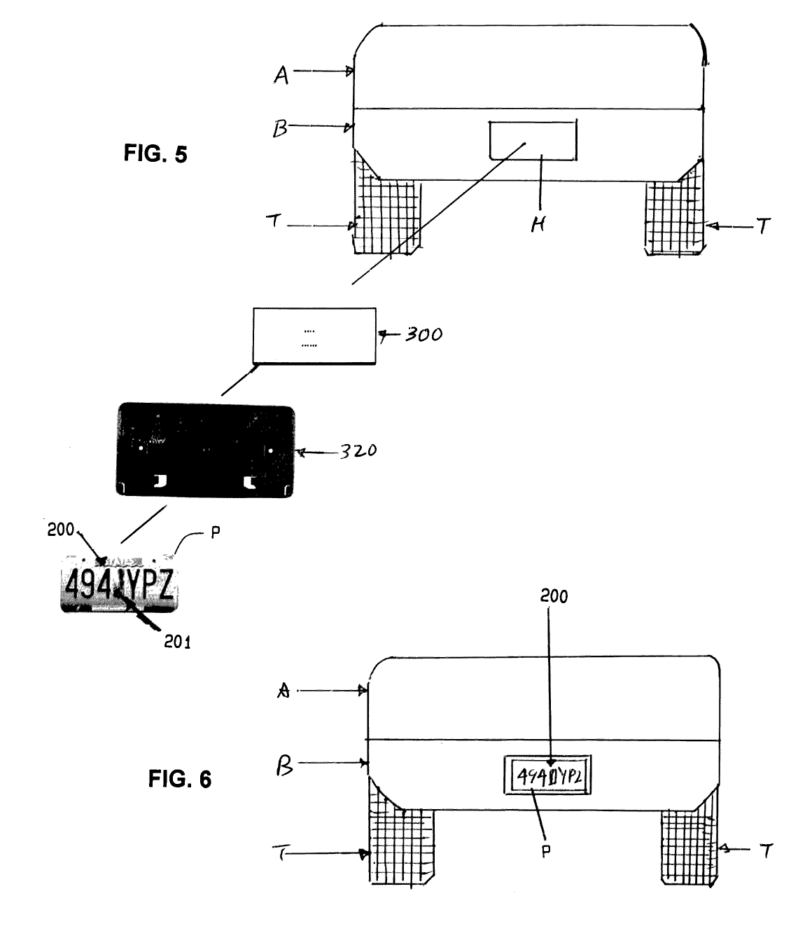

In reference to FIG. 3, FIG. 5 shows an exploded view of an installation of the indicator 200 upon a bumper B of an auto A. Preferably, this installation occurs upon the back bumper B but select U.S. states may require installation upon both the back and the front bumpers of an auto. The bumper typically spans across the width of the auto A and has a position between the body of the auto and the tires T as shown. A bumper typically has a place of attachment H for license plates often provided by the manufacturer of the auto. In this installation, a rectangular sensor 300 attaches to the bumper as at H. The sensor detects the presence of a backer 320 installed upon the sensor 300 but outwardly from the bum per. The backer includes a component detected by the sensor. The backer then receives a license plate P having the indicator 200 and its cover 201 installed upon it. The indicator also has a component detected by sensor. FIG. 6 shows the license plate P with the indicator installed upon the backer 302 which covers the sensor 300 installed between the backer and the bumper B. The indicator 200 and the sensor 300 both connect to the power source, such as the auto's electrical service 206 or a battery 208, or a solar cell. Upon removal of the license plate P from the backer 302, the backer 302 from the sensor 300, or the sensor 300 from the bumper, the present 5 invention detects that removal and so notes the time and position of the removal in the central server. If this removal is expected, such as when a subscriber replaces license plates or sells a vehicle, the invention does not issue an alarm. If this removal is not expected, such as in theft of the license plate with an attached detector 200, the invention notes the time and position of the removal, and then issues an alarm signal that alerts law enforcement on the back end. Once the plate has been removed unlawfully the system will disable on the front end, take a picture of the individual who is removing the plate, and communicate pertinent information to law enforcement on the back end, this process will be done in situations that are similar to that of the stolen car as at 125.

From the aforementioned description, a device and method for validating license plates has been described. The device and method for validating license plates is uniquely capable of displaying vehicle registration and insurance coverage in real time visually to the public and to law enforcement. The device and method for validating license plates and its various components may be may be manufactured from many materials, including but not limited to, steel, aluminum, polymers, ferrous and nonferrous metal foils, their alloys, and composites.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like when they appear-are used merely as labels, and are not intended to impose numerical requirements on their objects.

The above description is intended to be illustrative, and not restrictive. For example, the above described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled. As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A method to identify vehicles with a lapsed status comprising: assembling subscribers;
entering data of the subscribers into a central server; deploying indicators upon the license plates of the subscribers; requesting data related to the subscribers from third party databases; comparing a response about a subscriber from a third party
database against criteria within the central server; making a signal from the central server; transmitting the signal from the central server to an indicator;
and, illuminating the indicator in response to the signal.

2. The method to identify vehicles of claim 1 further comprising: is said making a signal including a signal for constant illumination of an indicator or a signal for intermittent illumination of an indicator.

3. The method to identify vehicles of claim 1 further comprising: said transmitting the signal including sending the signal upon one of cellular telephone, short message service, microwave, and radio.

4. The method to identify vehicles of claim 1 further comprising: said requesting data including submitting a request to law enforcement databases and transmitting a signal to illuminate an indicator when said law enforcement database reports a stolen vehicle having an indicator.

5. A device to identify a vehicle with a lapsed status, said device comprising: a base adapted to affix to a vehicle; a processor upon said base; an antenna upon said base in communication with said processor; a power source in communication with said processor; a light source in communication with said power source and with said processor; and, 5 a cover upon said base concealing said processor, said antenna, and said power source, and said cover leaving said light source exposed; wherein upon receipt of a certain signal by said antenna, said antenna relays said certain signal to said processor and said processor directs said light source to illuminate.

6. The vehicle identifying device of claim 5 further comprising: said power source being a battery with at least a two year life span. 7. The vehicle identifying device of claim 5 further comprising: said certain signal triggering said processor to illuminate said light source constantly.

8. The vehicle identifying device of claim 5 further comprising: said certain signal triggering said processor to illuminate said light source intermittently. 9. A device to identify a vehicle with a lapsed status in combination with a government supplied license plate, said device comprising: a base adapted to affix to the license plate; a processor upon said base; an antenna upon said base in communication with said processor; a power source in communication with said processor, said power source being one of a battery and a circuit into an electrical system of a vehicle; a light source in communication with said power source and with said processor; and, a cover upon said base concealing said processor, said antenna, and said power source, and said cover leaving said light source exposed; wherein upon receipt of a certain signal by said antenna, said antenna relays said certain signal to said processor and said processor 5 directs said light source to illuminate.
